(19) United States
(12) Patent Application Publication
(10) Pub. No.: US 2026/0110350 A1
(43) Pub. Date: Apr. 23, 2026

(54) BACK-DRIVABLE LINEAR ACTUATOR

(71) Applicant: Sanctuary Cognitive Systems Corporation, Vancouver (CA)

(72) Inventors: Amir Farzad Forughi, Vancouver (CA); Can Ozdemir, Vancouver (CA); Madhurjot Sohi, Surrey (CA)

(21) Appl. No.: 19/362,186

(22) Filed: Oct. 17, 2025

Related U.S. Application Data
(60) Provisional application No. 63/710,197, filed on Oct. 22, 2024.

(51) Int. Cl. F16H 25/22; F16H 25/20; F16H 25/24; H02P 6/28; H02P 29/40

(52) U.S. Cl. CPC F16H 25/2204; F16H 25/2003; F16H 25/24; H02P 6/28; H02P 29/40; F16H 2025/2062; H02P 2207/05

(57) ABSTRACT

A linear actuator includes a coupling stack having a shaft coupling, a first thrust bearing adjacent to a first end face of the shaft coupling, and a second thrust bearing adjacent to a second end face of the shaft coupling. The first thrust bearing and the second thrust bearing support axial loads applied to the shaft coupling. A ball screw includes a ball screw shaft extending through a bore of the first thrust bearing and rigidly coupled to the shaft coupling. A motor includes a motor shaft extending through a bore of the second thrust bearing and rigidly coupled to the shaft coupling. The shaft coupling, the ball screw shaft, and the motor shaft are axially aligned with a longitudinal axis of the actuator. The motor is operable to apply a torque to the motor shaft that is transmitted to the ball screw shaft through the shaft coupling.

### CROSS-REFERENCE TO RELATED APPLICATIONS

This application claims the benefit of U.S. Provisional Application No. 63/710,197 filed Oct. 22, 2024, the content of which is incorporated herein by reference.

### BACKGROUND

Robots are machines that can sense their environment and perform tasks autonomously or semi-autonomously or via teleoperation. Robots can have robotic hands (or end effectors) to use in performing dexterous manipulation. A robotic hand can have several degrees of freedom (DOF), each of which may be actuated by a corresponding actuator. In some cases, multiple DOFs (e.g., coupled DOFs or underactuated DOFs) may be actuated by a single actuator. In some cases, the design of the robotic hand may require that the actuators fit within the limited space of the hand.

### SUMMARY

Disclosed herein is a linear actuator that can be made in a small form factor with a relatively high force output. The linear actuator can be employed in actuation of robotic joints, such as robotic finger joints, and offers advantages where the actuator is required to fit within a limited space.

In a representative example, a linear actuator includes a coupling stack having a shaft coupling axially aligned with a longitudinal axis. The shaft coupling has a first end face and a second end face spaced apart along the longitudinal axis, a first coupling bore connected to the first end face, and a second coupling bore connected to the second end face. The coupling stack includes a first thrust bearing adjacent to the first end face of the shaft coupling. The first thrust bearing has a first bearing bore aligned with the first coupling bore. The first thrust bearing is configured to support an axial load applied to the shaft coupling in a first direction along the longitudinal axis. The coupling stack includes a second thrust bearing adjacent to the second end face of the shaft coupling. The second thrust bearing has a second bearing bore aligned with the second coupling bore. The second thrust bearing is configured to support an axial load applied to the shaft coupling in a second direction that is opposite to the first direction along the longitudinal axis. The linear actuator includes a ball screw having a ball screw shaft rigidly coupled to the shaft coupling. The ball screw shaft has an end disposed in the first coupling bore and extends through the first bearing bore. The linear actuator includes a motor having a motor shaft rigidly coupled to the shaft coupling. The motor shaft has an end disposed in the second coupling bore and extends through the second bearing bore. The motor is operable to apply a torque to the motor shaft that is transmitted to the ball screw shaft through the shaft coupling.

In another representative example, a method of actuator control includes measuring electrical current passing through a motor of an actuator. A motor shaft of the motor is rigidly coupled to a ball screw shaft of a ball screw of the actuator. The method includes determining a back-drive torque on the ball screw shaft. The method includes determining an opposing torque to output by the motor to resist the back-drive torque. The method includes determining an amount of electrical current to apply to the motor based at least in part on the opposing torque and applying the amount of electrical current to the motor.

### BRIEF DESCRIPTION OF THE DRAWINGS

FIG. 1 is an elevated view of a linear actuator.

FIG. 2 is a cross-sectional view of the linear actuator along line 2-2 as shown in FIG. 1.

FIG. 3 is a cross-sectional view of the linear actuator along line 3-3 as shown in FIG. 2.

FIG. 4 is an enlarged view of a portion of the linear actuator within rectangle 4 as shown in in FIG. 2.

FIG. 5 is an enlarged view of a portion of the linear actuator within rectangle 5 as shown in FIG. 3.

FIG. 6 is an enlarged view of a portion of the linear actuator within rectangle 5 as shown in FIG. 3, according to another example.

FIG. 7 is a cross-sectional view of the linear actuator as shown in FIG. 2 with a modification to include a rotary encoder.

FIG. 8A is a perspective view of a robotic finger with two linear actuators according to examples described herein.

FIG. 8B is a perspective view of the robotic finger as shown in FIG. 8A with a proximal interphalangeal (PIP) joint of the finger in a rotated position.

FIG. 8C is a perspective view of the robotic finger as shown in FIG. 8A with a metacarpophalangeal (MCP) joint of the finger in a rotated position.

FIG. 8D is a cross-sectional view of the robotic finger shown in FIG. 8A.

FIG. 8E is a cross-sectional view of the robotic finger as shown in FIG. 8D with a proximal interphalangeal joint of the finger in a rotated position.

FIG. 8F is a cross-sectional view of the robotic finger as shown in FIG. 8D with a metacarpophalangeal joint of the finger in a rotated position.

FIG. 8G is a cross-sectional view of the robotic finger as shown in FIG. 8D with proximal interphalangeal and metacarpophalangeal joints of the finger in rotated positions.

FIG. 9 is a schematic of an actuator control system.

FIG. 10 is a flow chart of a method of actuator control.

### DETAILED DESCRIPTION

For this description, certain specific details are set forth herein in order to provide a thorough understanding of disclosed technology. In some cases, as will be recognized by one skilled in the art, the disclosed technology may be practiced without one or more of these specific details, or may be practiced with other methods, structures, and materials not specifically disclosed herein. In some instances, well-known structures and/or processes associated with robots have been omitted to avoid obscuring novel and non-obvious aspects of the disclosed technology.

All the examples of the disclosed technology described herein and shown in the drawings may be combined without any restrictions to form any number of combinations, unless the context clearly dictates otherwise, such as if the proposed combination involves elements that are incompatible or mutually exclusive. The sequential order of the acts in any process described herein may be rearranged, unless the context clearly dictates otherwise, such as if one act or operation requests the result of another act or operation as input.

In the interest of conciseness, and for the sake of continuity in the description, same or similar reference characters may be used for same or similar elements in different figures, and description of an element in one figure will be deemed to carry over when the element appears in other figures with the same or similar reference character, unless stated otherwise. In some cases, the term “corresponding to” may be used to describe correspondence between elements of different figures. In an example usage, when an element in a first figure is described as corresponding to another element in a second figure, the element in the first figure is deemed to have the characteristics of the other element in the second figure, and vice versa, unless stated otherwise.

The word “comprise” and derivatives thereof, such as “comprises” and “comprising”, are to be construed in an open, inclusive sense, that is, as “including, but not limited to”. The singular forms “a”, “an”, “at least one”, and “the” include plural referents, unless the context dictates otherwise. The term “and/or”, when used between the last two elements of a list of elements, means any one or more of the listed elements. The term “or” is generally employed in its broadest sense, that is, as meaning “and/or”, unless the context clearly dictates otherwise. When used to describe a range of dimensions, the phrase “between X and Y” represents a range that includes X and Y. As used herein, an “apparatus” may refer to any individual device, collection of devices, part of a device, or collections of parts of devices.

The term “coupled” without a qualifier generally means physically coupled or linked and does not exclude the presence of intermediate elements between the coupled elements absent specific contrary language. The term “plurality” or “plural” when used together with an element means two or more of the element. Directions and other relative references (e.g., inner and outer, upper and lower, above and below, and left and right) may be used to facilitate discussion of the drawings and principles but are not intended to be limiting.

The headings and Abstract are provided for convenience only and are not intended, and should not be construed, to interpret the scope or meaning of the disclosed technology.

### Example I—Overview

Disclosed herein is a linear actuator that can output a relatively high force in a small form factor, has reliable force sensing, and is back-drivable. The linear actuator includes a ball screw and a motor to drive the ball screw. The linear actuator includes a coupling that connects the motor to the ball screw such that the torque of the motor can drive the ball screw. The coupling aligns and maintains alignment of the motor and the ball screw and isolates the motor from axial forces from the ball screw. The force output of the linear actuator can be determined in both the forward and reverse directions from the electrical current passing through the motor.

### Example II—Linear Actuator

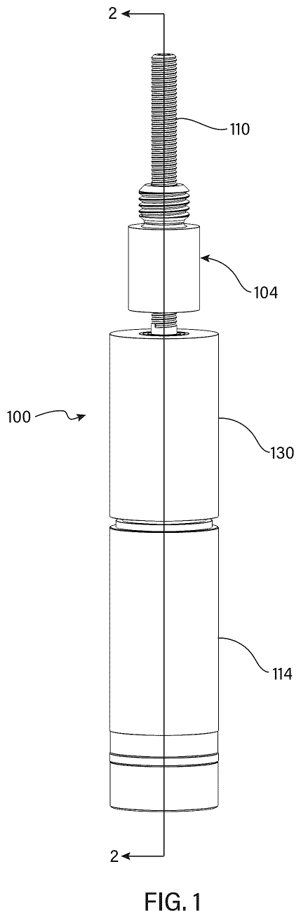

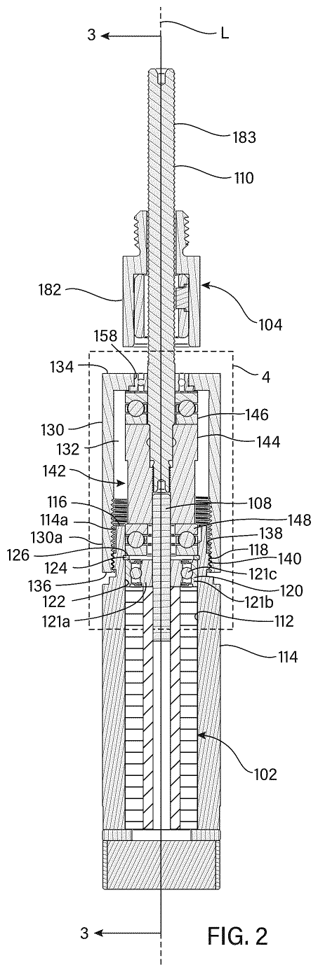

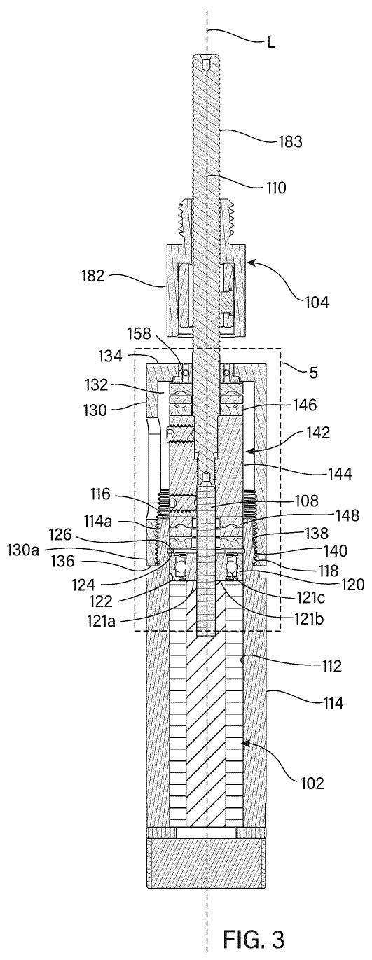

FIGS. 1-3 illustrate an example linear actuator 100 that can output a relatively high force in a small form factor. The linear actuator 100 includes a motor 102 (shown in FIGS. 2-3), a ball screw 104, and a coupling stack 142 (shown in FIGS. 2-3). The coupling stack 142 couples a motor shaft 108 (shown in FIGS. 2-3) of the motor 102 to a ball screw shaft 110 of the ball screw 104. The motor 102 can be operated to apply torque to the motor shaft 108. The coupling stack 142 allows rotational motion of the motor shaft 108 about a longitudinal axis L of the linear actuator 100 to cause rotation of the ball screw shaft 110 about the longitudinal axis L, or vice versa. To minimize wobbling and vibration of the actuator, the coupling stack 142 includes features to axially align the motor shaft 108 and the ball screw shaft 110 along the longitudinal axis L. To protect the motor 102 from damage, the coupling stack 142 includes features to prevent transmission of axial loads from the ball screw shaft 110 to the motor shaft 108.

The motor 102 can be any electrical motor in the appropriate form factor that can be used to drive the ball screw 104. For example, the motor 102 can be any direct-current (DC) motor (for example, but not limited to, permanent magnet DC motor, brushed DC motor, or brushless DC motor) with or without built-in gear reduction or gearhead. In one example, the motor 102 can be a brushless DC motor without gear reduction or gearhead. As shown in FIGS. 2-3, the motor 102 can be mounted in a chamber 112 of a motor casing 114, with the motor shaft 108 extending out of an open end 116 of the motor casing 114. An end portion 114a of the motor casing 114 including the open end 116 can be provided with a threaded surface (e.g., an externally threaded surface 118) for threaded coupling with another member of the linear actuator 100 (e.g., a coupling cover 130 as will be further described herein).

In some examples, a radial bearing 120 can be arranged to take radial loads from the motor shaft 108. For example, the radial bearing 120 can be mounted in an annular groove 122 formed between the motor shaft 108 and the motor casing 114. The radial bearing 120 can include an inner ring 121a that engages the motor shaft 108, an outer ring 121b that circumscribes the inner ring 121a and is radially supported by the motor casing 114, and one or more rings (or sets) of bearing elements 121c (only one ring/set of bearing elements is shown) disposed between the inner and outer rings 121a, 121b. The inner and outer rings 121a, 121b can include races for movement of the bearing elements 121c. In the illustrated example, the radial bearing 120 is depicted as a ball bearing (e.g., the bearing elements 121c are balls). However, other types of radial bearings may be used for the radial bearing 120 (e.g., straight roller bearing, tapered roller bearing, spherical bearing, duplex bearings, or needle roller bearing).

The radial bearing 120 may be mounted on the motor 102 (e.g., with the inner ring 121a on a rotor part of the motor 102, the outer ring 121b on a stator part of the motor 102, and the bearing elements 121c extending between the inner and outer rings 121a, 121b). The radial bearing 120 can be retained in the annular groove 122 by a retainer ring 124 (e.g., a snap ring) that engages the outer ring 121b and is supported by the motor casing 114 (e.g., by fitting the retainer ring 124 in a groove in a wall of the motor casing 114). In some examples, the retainer ring 124 projects radially from the wall of the motor casing 114 to form an annular shoulder 126 within the chamber 112 that may be used to support a member of the coupling stack 142 (e.g., a second thrust bearing 148 of the coupling stack 142 as will be further described herein).

A coupling cover 130 includes a chamber 132, a closed end 134 at one end of the chamber 132, and an open end 136 at another end of the chamber 132. An end portion 130a of the coupling cover 130 including the open end 136 can be provided with a threaded surface (e.g., an internally threaded surface 138) for threaded coupling with the motor casing 114. In the illustrated example, the end portion 114a of the motor casing 114 is inserted into the end portion 130a of the coupling cover 130 (through the open end 136), and a threaded connection 140 is formed between the coupling cover 130 and the motor casing 114 by engagement of the complementary internally and externally threaded surfaces 118, 138. The threaded connection 140 axially aligns the motor casing 114 and the coupling cover 130 along the longitudinal axis L.

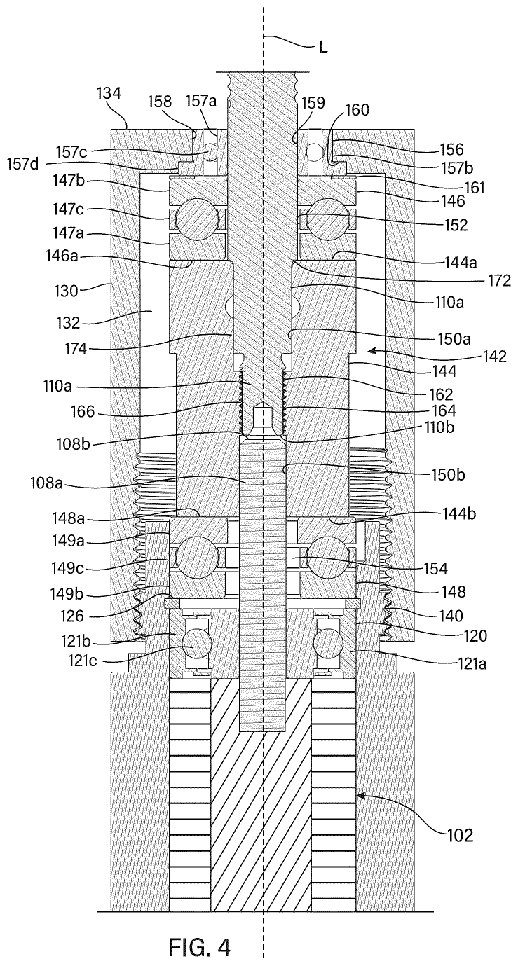

In some examples, as shown more clearly in FIG. 4, the closed end 134 of the coupling cover 130 includes a central opening 158 and an annular shoulder 160 formed in the central opening 158. The annular shoulder 160 is in opposed relation to the annular shoulder 126 formed in the motor casing 114 when the threaded connection 140 is formed between the motor casing 114 and the coupling cover 130. The coupling stack 142 is disposed within the chamber 132 and extends between the opposed annular shoulders 126, 160. This arrangement allows the preload from the coupling cover 130 to be effective in preloading the coupling stack 142 (e.g., the torque results in opposing forces acting on the shoulders 126, 160 that can preload the coupling stack 142). The preload from the coupling cover 130 is generated by threading the coupling cover 130 onto the motor casing 114. The preload from the coupling cover 130 eliminates backlash from the coupling stack 142 shuttling up and down.

The coupling stack 142 includes a shaft coupling 144, a first thrust bearing 146, and a second thrust bearing 148. The term “thrust bearing” as used herein refers to a bearing that is designed to support axial loads. The thrust bearing may be a part of a combined bearing that provides other bearing functions. The shaft coupling 144 may be a generally cylindrical body having an axial axis aligned with the longitudinal axis L. The shaft coupling 144 includes a first end face 114a and a second end face 114b spaced apart along the longitudinal axis L. The first thrust bearing 146 is adjacent to the first end face 144a and has a bearing face 146a positioned in contact with the first end face 144a. The second thrust bearing 148 is adjacent to the second end face 114b and has a bearing face 148a positioned in contact with the second end face 144b.

The shaft coupling 144 has a first coupling bore 150a that is connected to the first end face 144a and sized to receive an end portion of the ball screw shaft 110. The shaft coupling 144 has a second coupling bore 150b that is connected to the second end face 144b and sized to receive an end portion of the motor shaft 108. The coupling bores 150a, 150b are axially aligned along the longitudinal axis L. In some examples, the coupling bores 150a, 150b may be connected to each other within the shaft coupling 144. In this case, the lengths of the coupling bores 150a, 150b, or the lengths of the end portions of the shafts 108, 110 inserted into the respective coupling bores 150a, 150b, are such that the opposed ends 108b, 110b of the shafts 108, 110 do not contact each other within the shaft coupling 144 since such contact could result in unwanted transfer of axial loads from the ball screw shaft 110 to the motor shaft 108.

In the illustrated example, the first thrust bearing 146 is positioned proximate the closed end 134 of the coupling cover 130 and engages the annular shoulder 160 of the coupling cover 130 either directly or through a structure coupled to the coupling cover 130 (e.g., through a shim 161 and radial bearing 156 as will be further described herein). The second thrust bearing 148 engages (e.g., sits on) the annular shoulder 126. Opposing forces can be applied to the shoulders 126, 160 during preloading of the coupling stack 142 to establish firm contact between the thrust bearing faces 146a, 148a and the respective end faces 144a, 144b of the shaft coupling 144. An appropriate amount of preload can eliminate backlash or free-play of parts in the coupling stack 142.

In the illustrated example, the first thrust bearing 146 includes a first washer 147a (which includes the bearing face 146a), a second washer 147a, and one or more rings (or sets) of bearing elements 147c (only one ring of bearing elements is shown) between the thrust washers 147a, 147b. In the illustrated example, the first thrust bearing 146 is depicted as a thrust ball bearing (e.g., the bearing elements 147c are depicted as balls). In other examples, the first thrust bearing 146 may have a different design (e.g., thrust tapered roller bearing or thrust spherical roller bearing) with a different type of bearing elements.

The first thrust bearing 146 includes a bearing bore 152 that is disposed between the central opening 158 of the closed end 134 of the coupling cover 130 and the first coupling bore 150a of the shaft coupling 144. The bearing bore 152 and the central opening 158 and first coupling bore 150a can be axially aligned along the longitudinal axis L. The ball screw shaft 110 can extend through the central opening 158 and bearing bore 152 into the first coupling bore 150a of the shaft coupling 144.

The second thrust bearing 148 includes a first washer 149a (which includes the bearing face 148a), a second washer 149b, and one or more rings (or sets) of bearing elements 149c (only one ring of bearing elements is shown) between the washers 147a, 147b. In the illustrated example, the second thrust bearing 148 is depicted as a thrust ball bearing (e.g., the bearing elements 149c are balls). In other examples, the second thrust bearing 148 may have a different design (e.g., thrust tapered roller bearing or thrust spherical roller bearing) with a different type of bearing elements.

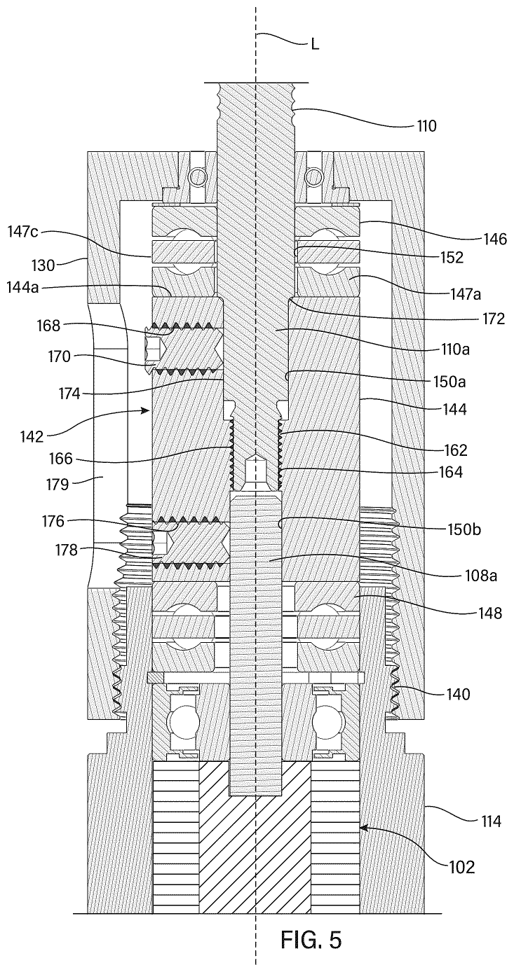

The diameter of the bearing bore 152 of the first thrust bearing 146 at the first washer 147a and the ring(s) of bearing elements 147c can be larger than the diameter of the ball screw shaft 110 extending therethrough to avoid transferring unwanted radial loads from the ball screw shaft 110 to the input side of the first thrust bearing 146 (see the gap between the ball screw shaft 110 and the inner diameter of the first thrust bearing 146 in FIG. 5).

In some examples, the coupling stack 142 may include a radial bearing 156 arranged adjacent to the first thrust bearing 146 to take radial loads from the ball screw shaft 110. In the illustrated example, the radial bearing 156 is mounted within the central opening 158 formed in the closed end 134 of the coupling cover 130 and has a bearing bore 159 that is aligned with the bearing bore 152 of the first thrust bearing 146 and which can receive the ball screw shaft 110. The inner diameter of the radial bearing 156 (or the diameter of the bearing bore 152) can be sized to allow the radial bearing 156 to engage the portion of the ball screw shaft 110 extending through the bearing bore 152 and take radial loads from the ball screw shaft 110.

The radial bearing 156 can include an inner ring 157a that defines the bearing bore 159, an outer ring 157b that circumscribes the inner ring 157a and is radially supported by the coupling cover 130, and one or more rings of bearing elements 157c (only one ring of bearing elements is shown) disposed between the rings 157a, 157b. The rings 157a, 157b can include races for movement of the bearing elements 157c. In the illustrated example, the radial bearing 156 is depicted as a ball bearing (e.g., the bearing elements 157c are balls). However, other types of radial bearings may be used (e.g., straight roller bearing, tapered roller bearing, spherical bearing, or needle roller bearing).

In the illustrated example, the outer ring 157b of the radial bearing 156 includes a flange portion 157d that engages the annular shoulder 160 of the coupling cover 130. A shim 161 is disposed in between the flange portion 157d of the outer ring 157b of the radial bearing 156 and the first thrust bearing 146 to form a mechanical link between the first thrust bearing 146 and the annular shoulder 160. To avoid radial loads applied to the inner ring 157a and the bearing elements 157c from being transferred to the first thrust bearing 146, contact between the shim 161 and the radial bearing 156 is preferably limited to the outer ring 157b area. In this arrangement, since the flange portion 157d abuts the annular shoulder 160, preloading of the coupling stack 142 will also serve to axially restrain the radial bearing 156.

In some examples, the radial bearing 156 may be omitted, in which case the first thrust bearing 146 can engage the annular shoulder 160 directly or through a shim. In other examples, the radial bearing 156 and the first thrust bearing 146 may be replaced with a combined thrust and axial bearing that can support both axial and radial loads (i.e., the radial bearing and the first thrust bearing can be integrated). The combined thrust and axial bearing may have a portion that is mounted within the central opening 158 of the coupling cover 130 and another portion that contacts the shaft coupling 144.

The second thrust bearing 148 includes a bearing bore 154 that is aligned with the second coupling bore 150b of the shaft coupling 144 and through which the motor shaft 108 may extend into the second coupling bore 150b. The diameter of the bearing bore 154 can be larger than the diameter of the motor shaft 108 extending therethrough such that when the motor shaft 108 is centered within the bearing bore 154, the inner diameter of the second thrust bearing 148 does not engage the motor shaft 108, which can avoid unwanted transfer of radial loads from the motor shaft 108 to the second thrust bearing 148.

When the motor casing 114 is threaded into the coupling cover 130 to form the threaded connection 140, the coupling stack 142 is positioned between the opposed annular shoulders 126, 160. Torque can be applied to the threaded connection 140 until the second thrust bearing 148 engages the annular shoulder 126 and the first thrust bearing 146 engages the annular shoulder 160 directly or through the shim 161 and flange portion 157b of the radial bearing 156. Additional torque applied to the threaded connection 140 can act to preload the coupling stack 142 to establish and maintain a firm contact between the first and second thrust bearings 146, 148 and the shaft coupling 144.

In a fully assembled state of the linear actuator 100, the motor shaft 108 is fixedly or rigidly coupled to the shaft coupling 144 so that rotation of the motor shaft 108 results in rotation of the shaft coupling 144. In some examples, a motor shaft portion 108a received in the second coupling bore 150b can be secured to the second coupling bore 150b using any suitable means.

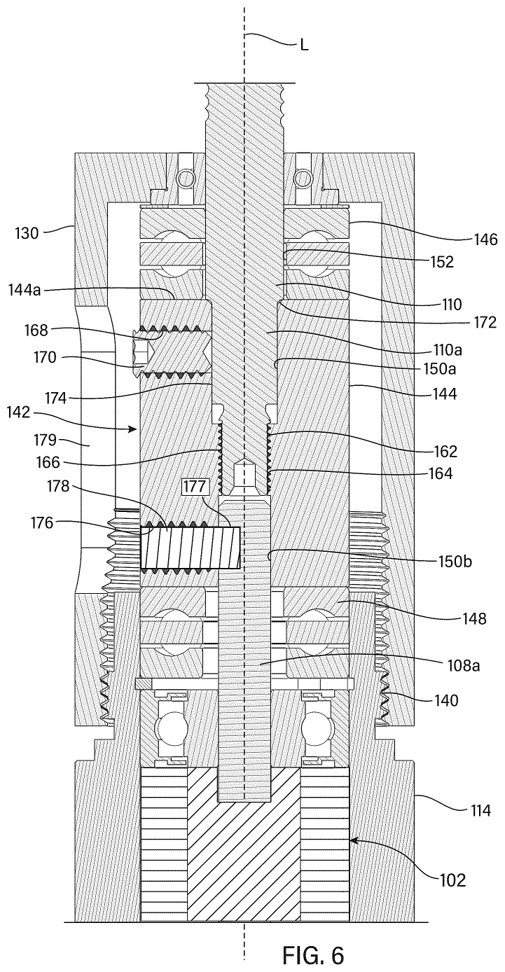

In some examples, it may be desirable that the motor shaft portion 108a is free to move longitudinally within the second coupling bore 150b during preloading of the coupling stack 142. In these examples, the method of securing the motor shaft portion 108a to the second coupling bore 150b may allow the motor shaft portion 108a to be secured after preloading the coupling stack 142. For example, as illustrated in FIG. 5, the shaft coupling 144 can include a tap hole 176 that extends from an outer surface of the shaft coupling 144 to the second coupling bore 150b. After preloading the coupling stack 142, a threaded pin 178 can be threaded through the tap hole 176 to engage the motor shaft portion 108a in the second coupling bore 150b and pin the motor shaft portion 108a to the second coupling bore 150b. The coupling cover 130 can include an access opening 179 that can be aligned with the tap hole 176 to enable insertion of the threaded pin 178 into the tap hole 176 after the threaded connection 140 between the coupling cover 130 and the motor casing 114 has been formed. In some examples, the motor shaft portion 108a may be further locked in place by forming a hole in the motor shaft portion 108a that can be aligned with the tap hole 176 and that can receive an end portion of the threaded pin 178 (see hole 177 in FIG. 6).

The ball screw shaft 110 is rotationally fixed to the shaft coupling 144 so that rotation of the shaft coupling 144 results in rotation of the ball screw shaft 110. In some examples, a screw shaft portion 110a received in the first coupling bore 150a is secured to the first coupling bore 150a using any suitable means. In the illustrated example, the screw shaft portion 110a includes an externally threaded surface 162 and the first coupling bore 150a includes an internally threaded surface 164 that can engage each other to form a threaded connection 166 between the screw shaft portion 110a and the first coupling bore 150a.

In some examples, as shown in FIGS. 5 and 6, the shaft coupling 144 may include a tap hole 168 that extends from the outer surface of the shaft coupling 144 to the first coupling bore 150a. A threaded pin 170 may be threaded through the tap hole 168 to engage the screw shaft portion 110a and further securely lock the screw shaft portion 110a to the first coupling bore 150a. The screw shaft portion 110a may be secured in the first coupling bore 150a with the threaded pin 170 before or after preloading the coupling stack 142. The tap hole 168 may be accessed through the access opening 179 formed in the coupling cover 130.

In some examples, to facilitate centering of the screw shaft portion 110 in the passage formed by the first coupling bore 150a, bearing bore 152 of the first thrust bearing 146, and bearing bore 159 of the radial bearing 156, the screw shaft portion 110a may have a first surface 172 that engages the first end face 144a of the shaft coupling 144 and a second surface 174 that engages a non-threaded portion of the first coupling bore 150a. The surfaces 172, 174 can be orthogonal to each other, with the first surface 172 being transverse to the axial axis of the ball screw shaft 110 (or the longitudinal axis L). The first and second surfaces 172, 174 may form a shoulder on the ball screw shaft 110.

Returning to FIGS. 2 and 3, the ball screw 104 includes a nut 182 that is disposed around the ball screw shaft 110. The ball screw shaft 110 has a helical groove 183, and the nut 182 has a helical groove with a matching profile to the helical groove 183 of the ball screw shaft 110 as is known in the art of ball screws. The ball screw 104 includes balls (not shown) (e.g., steel balls) that roll along a helical path formed by the helical grooves of the ball screw shaft 110 and nut 182. The balls can be recirculated through the nut 182 using any known ball recirculation system in the art of ball screws. The balls support relative rotation between the nut 182 and the ball screw shaft 110.

Electrical current can be applied to the motor 102 to cause the motor 102 to output a torque that rotates the motor shaft 108 about the longitudinal axis L. Since the motor shaft 108 is rigidly coupled to the shaft coupling 144, rotation of the motor shaft 108 causes rotation of the shaft coupling 144 about the longitudinal axis L. Since the shaft coupling 144 is rigidly coupled to the ball screw shaft 110, rotation of the shaft coupling 144 causes rotation of the ball screw shaft 110 about the longitudinal axis L. If the nut 182 is held rotationally fixed about the longitudinal axis L (i.e., the nut 182 is not allowed to rotate about the longitudinal axis L), the nut 182 will be linearly displaced along the ball screw shaft 110 in response to rotation of the ball screw shaft 110. The nut 182 can be held rotationally fixed, for example, by a mechanism of a driven component (e.g., a robotic finger or linkage) coupled to the nut 182 (see Example III).

Excluding other factors such as inertial and gravitational forces, the force output of the actuator can be calculated and is a function of axial thrust, lead of the ball screw 104 (i.e., the linear distance the nut 182 makes per one screw revolution), and efficiency of the ball screw 104. Axial thrust is dependent on the torque applied by the motor 102. The amount of torque applied by the motor 102 is determined by the amount of electrical current passing through the motor 102.

Since the ball screw 104 is back-drivable, a force applied on the nut 182 causes a torque to be applied on the ball screw shaft 110. The torque applied to the ball screw shaft 110 by the nut 182 is experienced by the motor shaft 108 since the motor shaft 108 is rigidly coupled to the ball screw shaft 110 through the shaft coupling 144. If the nut 182 is held rotationally fixed while the nut 182 applies torque to the ball screw shaft 110, the nut 182 can be linearly displaced along the ball screw shaft 110.

To keep the position of the actuator at a setpoint, the torque applied to the motor shaft 108 has to be the same as the torque applied to the ball screw shaft 110. With this information, it is possible to calculate the force output of the actuator regardless of the direction in which the ball screw 104 is driven.

There are various approaches to calculating the force output of the actuator. For a brushless DC motor, for example, the output torque of the motor is directly proportional to electrical current. In one example, an impedance controller can be used to correlate force output of the actuator to current passing through the motor for either drive direction of the ball screw 104. In other examples, empirical or theoretical models can be used to calculate the force output.

The coupling stack 142 manages axial loads from the ball screw shaft 110 using the thrust bearings 146, 148. Any downward axial force from the ball screw shaft 110 that pushes the shaft coupling 144 in a downward direction is taken by the second thrust bearing 148 and dissipated to the motor casing 114. The motor shaft 108 is unaffected by the downward axial force. Any upward axial force from the ball screw shaft 110 that pulls the shaft coupling 144 in an upward direction is taken by the first thrust bearing 146 and dissipated to the coupling cover 130. The motor shaft 108 is again unaffected by the upward axial force.

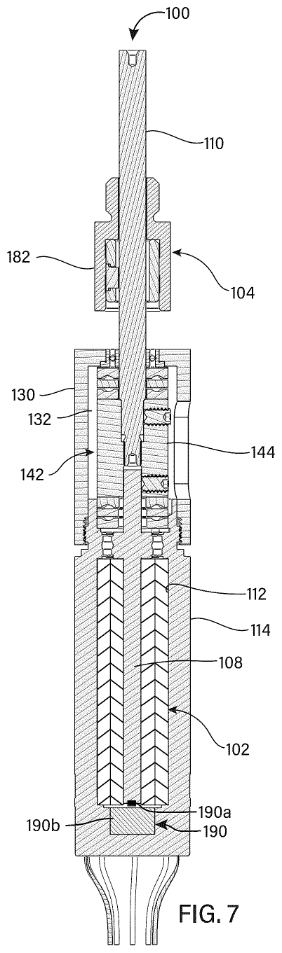

Referring to FIG. 7, the linear actuator 100 can include a rotary encoder 190 positioned to measure the rotational position of the motor shaft 108. The output of the rotary encoder 190 can be used to determine controls for the linear actuator 100 (e.g., an amount of current to apply to the motor 102 for a particular actuation setpoint). The rotary encoder 190 may be, for example, a magnetic encoder or an optical encoder. The rotary encoder 190 may be an absolute encoder or an incremental encoder.

In the illustrated example, the rotary encoder 190 is an absolute encoder having a magnet 190a and a sensing circuit 190b. The magnet 190a is coupled to the motor shaft 108 so that the magnet 190a can rotate with the motor shaft 108. The sensing circuit 190b is coupled to the motor casing 114 so that the magnet 190a can rotate relative to the sensing circuit 190b. The sensing circuit 190b includes a magnetic sensor that measures changes in the magnetic field distribution as the magnet 190a rotates with the motor shaft 108. The sensing circuit 190b includes circuitry that can determine the position of the motor shaft 108 from the output of the magnetic sensor.

Other arrangements of the components of the rotary encoder 190 may be possible while achieving effective measurement of the rotational position of the motor shaft 108. For example, the magnet 190a may be coupled to the rotor part of the motor 102, and the sensing circuit 190b may be coupled to the motor casing 114 in a position to sense the changes in the magnetic field distribution as the magnet 190a rotates with the rotor part of the motor 102.

### Example III—Robotic Finger With Integrated Linear Actuators

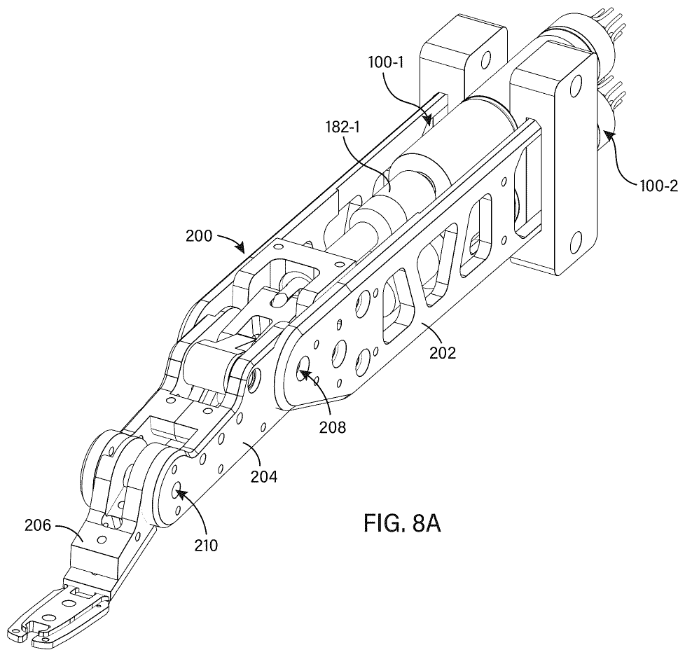

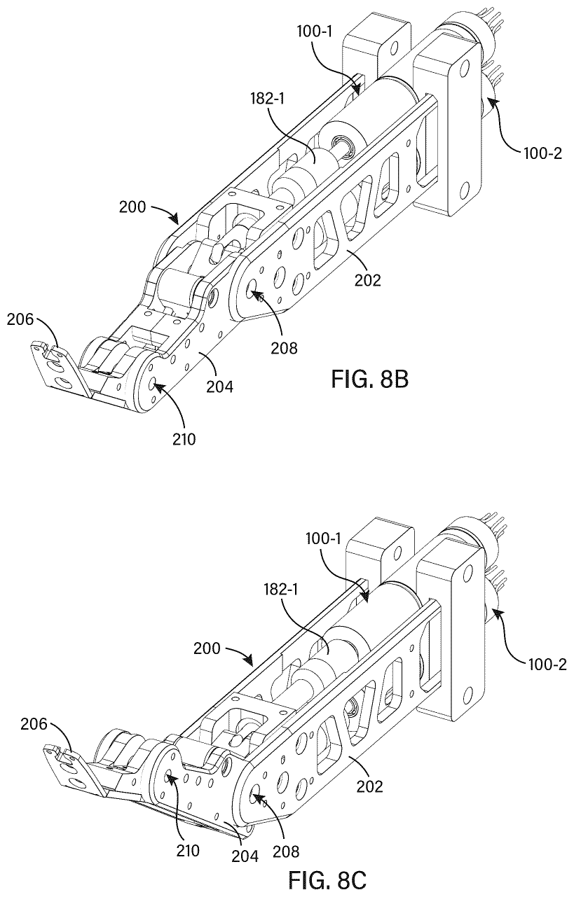

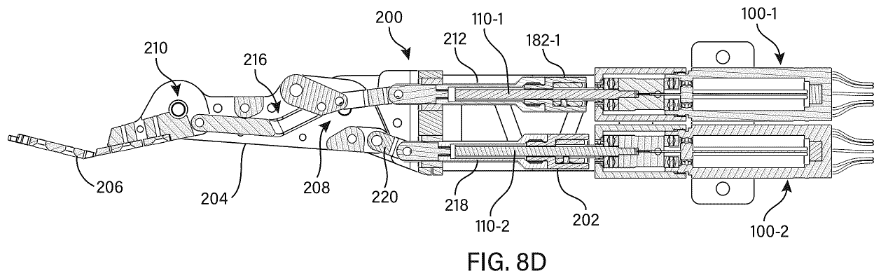

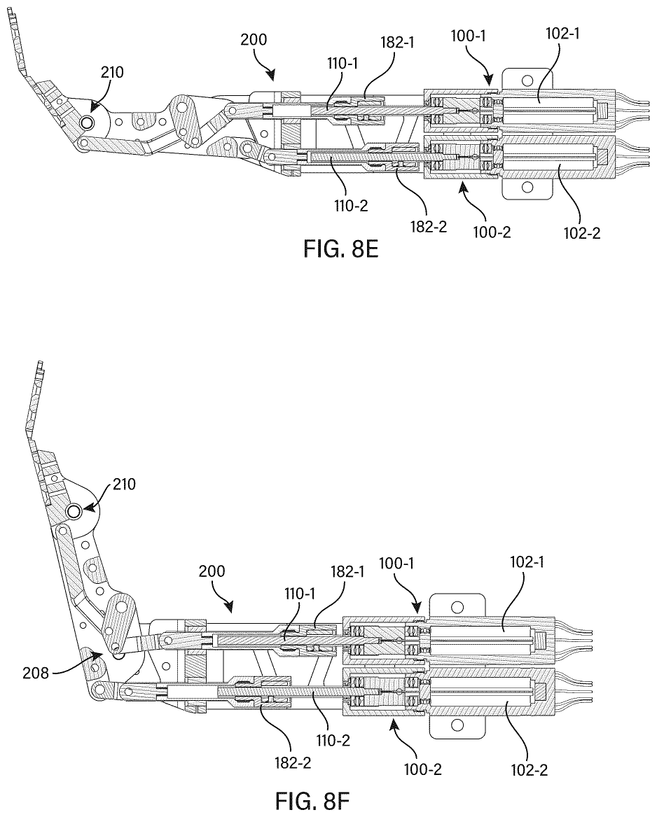

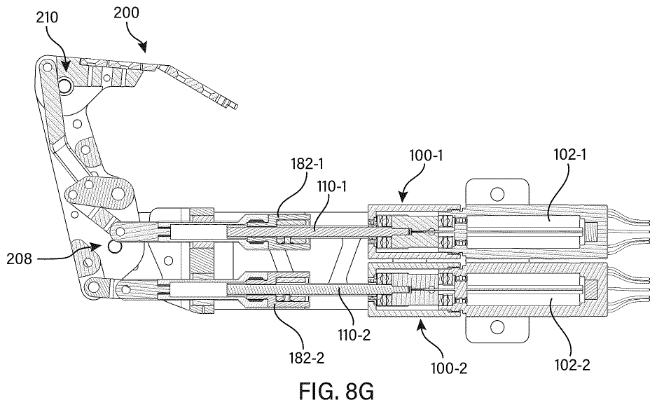

FIG. 8A illustrates two linear actuators 100-1, 100-2, as described in Example II, coupled to an example robotic finger 200. The example robotic finger 200 has a base 202, a proximal digit segment 204, and a distal digit segment 206. The proximal digit segment 204 is coupled to the base 202 at a first joint 208 (or metacarpophalangeal (MCP) joint) and to the distal digit segment at a second joint 210 (proximal interphalangeal (PIP) joint). The robotic finger 200 can be bent at each of the joints 208, 210. The first linear actuator 100-1 can be operated to rotate the PIP joint 210 (see bending of the robotic finger 200 at the second joint 210 in FIG. 8B). The second linear actuator 100-2 can be operated to rotate the first joint 208 (see bending of the robotic finger 200 at the MCP joint 208 in FIG. 8C).

Referring to FIG. 8D, the nut 182-1 of the first linear actuator 100-1 is attached to a first end of a linkage 212. The second end of the linkage 212 is coupled to the PIP joint 210 via a mechanism 216. The linkage 212 is in the form of a tube so that the ball screw shaft 110-1 of the first linear actuator 100-1 can extend into the bore of the linkage 212, which can help with maintaining a linear motion of the linkage 212 as the nut 182-1 moves linearly along the ball screw shaft 110-1.

The nut 182-2 of the second linear actuator 100-2 is attached to a first end of a linkage 218. The second end of the linkage 218 is coupled to the MCP joint 208 via another linkage 220. The linkage 218 is in the form of a tube so that the ball screw shaft 110-2 of the second linear actuator 100-2 can extend into the bore of the linkage 218, which can help with maintaining a linear motion of the linkage 218 as the nut 182-2 moves linearly along the ball screw shaft 110-2.

FIG. 8E shows inward rotation of the PIP joint 210 by movement of the nut 182-1 to the left. The PIP joint 210 can be rotated outward by moving the nut 182-1 to the right. The terms “left” and “right” are relative to the orientation of the drawing on the page. The nut 182-1 moves along the ball screw shaft 110-1 by applying current to the motor 102-1 of the first linear actuator 110-1.

FIG. 8F shows inward rotation of the MCP joint 208 by movement of the nut 182-2 to the left. The MCP joint 208 can be rotated outward by moving the nut 182-2 to the right. The nut 182-2 moves along the ball screw shaft 110-2 by applying current to the motor 102-2 of the second linear actuator 110-2.

Both nuts 182-1, 182-2 can be moved to achieve a target finger pose. For example, FIG. 8G shows both nuts 182-1, 182-2 moved to the left to achieve the pose shown in the figure.

### Example IV—Actuator Control System

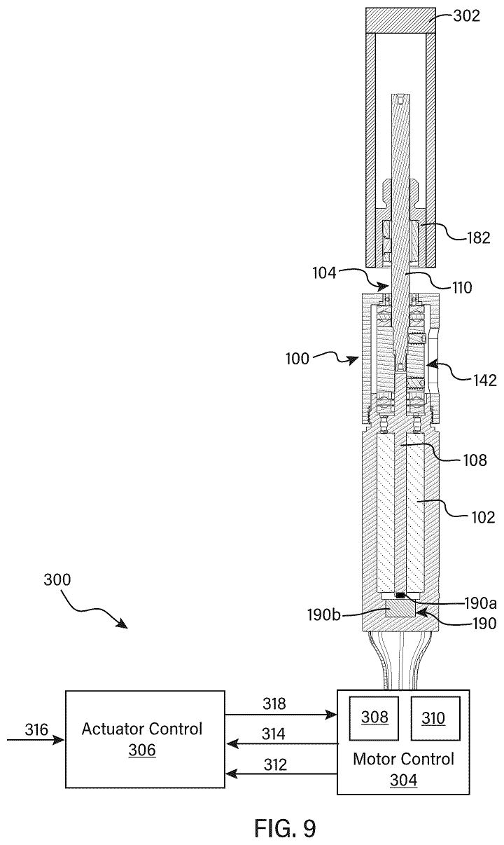

FIG. 9 illustrates a system 300 of controlling the linear actuator 100 to actuate a driven component 302. In the example, the drive component 302 is coupled to the nut 182 of the ball screw 104 of the linear actuator 100. The driven component 302 can be any component to be actuated by movement of the nut 182 relative to the ball screw shaft 110 (e.g., a component of a robotic finger as described in Example III).

The system 300 includes a motor control 304 and an actuator control 306. The motor control 304 is connected to the linear actuator 100.

The motor control 304 can include a power supply 308 from which electrical current can be supplied to the motor 102 of the linear actuator 100. The motor control 304 can include a current sensor 310 that can measure the electrical current passing through the motor 102. The motor control 300 can receive position information from the sensing circuit 190b of the position feedback sensor 190 (e.g., rotary encoder) arranged to track the position of the motor shaft 108.

The actuator control 306 is in communication with the motor control 304. The actuator control 306 can receive current feedback 312 from the motor control 300. The current feedback 312 can be generated from the output of the current sensor 310. The actuator control 306 can receive position feedback 314 from the motor control 300. The position feedback 314 can be generated from the output of the sensing circuit 190b. The current feedback 312 and position feedback 314 can represent the actuator state.

The actuator control 306 can receive an actuator command 316 from a control system (not shown) and output a motor command 318 for the motor control 304 based on the actuator command 316 and the actuator state. The actuator command 316 can include a position setpoint or a force setpoint. The position setpoint may indicate an absolute position or a relative position (e.g., relative to the position state of the actuator). The force setpoint may indicate an absolute force or a relative force (e.g., relative to the output force state of the actuator). The motor command 318 can include an amount of current to apply to the motor 102 and in what direction the current should be applied.

Because the ball screw 104 is back-drivable, external load on the nut 182 can apply a back-drive torque to the ball screw shaft 110. Since the ball screw shaft 110 is rigidly coupled to the motor shaft 108 through the coupling stack 142, the back-drive torque can be observed at the motor 102. To maintain a setpoint for the actuator, the drive torque outputted by the motor 102 needs to be sufficient to oppose the back-drive torque. The back-drive torque causes the motor 102 to behave like a generator. The electrical current passing through the motor 102 due to the back-drive torque can be detected from the current feedback 312. The minimum amount of electrical current to apply to the motor 102 so that the back-drive torque is opposed can be determined based on the electrical current detected from the current feedback 312.

### Example V—Actuator Control Method

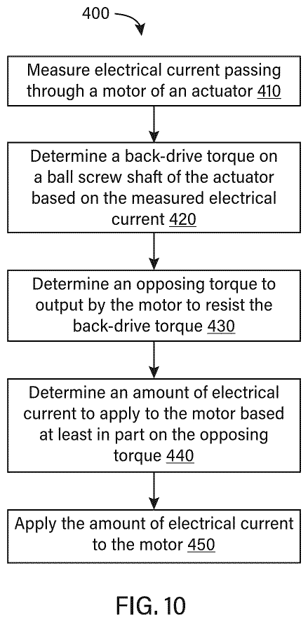

FIG. 10 illustrates a method 400 of actuator control that may performed by the system 300 described in Example IV and illustrated in FIG. 9.

At 410, the method can include measuring the electrical current passing through the motor of the actuator. For example, the electrical current passing through the motor 102 can be measured by the current sensor 310 (see FIG. 9).

At 420, the method can include determining a back-drive torque applied to the ball screw shaft of the actuator based on the electrical current measured in operation 410. Back-drive torque can be applied to the ball screw shaft by external load acting on the ball screw nut. As described in Example II, the ball screw shaft 110 is rigidly coupled to the motor shaft 108 through the coupling stack 142, and the motor shaft 108 is coupled to the motor 102. Because of the rigid coupling between the ball screw shaft 110 and the motor shaft 108, the motor 102 can observe the back-drive torque on the ball screw shaft 110.

At 430, the method can include determining an opposing torque to output by the motor to resist the back-drive torque. The opposing torque can be, for example, the same as the back-drive torque or can be slightly greater than the back-drive torque.

At 440, the method can include determining an amount of electrical current to apply to the motor based at least in part on the opposing torque. A first amount of electrical current needed for the motor to output the opposing torque can be determined. In some examples, if the actuator needs to maintain a force setpoint in addition to opposing the back-drive torque, a second amount of electrical current can be determined based on the drive torque needed to move the actuator to the force setpoint in the absence of the back-drive torque. The amount of electrical current determined in operation 440 can be the first amount of electrical current or a sum of the first amount of electrical current and the second amount of electrical current.

At 450, the method can include applying the amount of electrical current determined in operation 440 to the motor.

### Additional Examples

Additional examples based on principles described herein are enumerated below. Further examples falling within the scope of the subject matter can be configured by, for example, taking one feature of an example in isolation, taking more than one feature of an example in combination, or combining one or more features of one example with one or more features of one or more other examples.

Example 1: A linear actuator comprises a coupling stack including a shaft coupling axially aligned with a longitudinal axis, the shaft coupling comprising a first end face and a second end face spaced apart along the longitudinal axis, a first coupling bore connected to the first end face, and a second coupling bore connected to the second end face; a first thrust bearing adjacent to the first end face of the shaft coupling and having a first bearing bore aligned with the first coupling bore, the first thrust bearing configured to support an axial load applied to the shaft coupling in a first direction along the longitudinal axis; and a second thrust bearing adjacent to the second end face of the shaft coupling and having a second bearing bore aligned with the second coupling bore, the second thrust bearing configured to support an axial load applied to the shaft coupling in a second direction that is opposite to the first direction along the longitudinal axis; a ball screw shaft rigidly coupled to the shaft coupling, wherein the ball screw shaft has an end disposed in the first coupling bore and extends through the first bearing bore; and a motor having a motor shaft rigidly coupled to the shaft coupling, wherein the motor shaft has an end disposed in the second coupling bore and extends through the second bearing bore, and wherein the motor is operable to apply a torque to the motor shaft that is transmitted to the ball screw shaft through the shaft coupling.

Example 2: A linear actuator according to Example 1, wherein the first coupling bore and the second coupling bore are axially aligned with the longitudinal axis.

Example 3: A linear actuator according to Example 1 or 2, further comprising a coupling cover disposed around the coupling stack and mechanically coupled to the first thrust bearing.

Example 4: A linear actuator according to Example 3, further comprising a motor casing disposed around the motor and mechanically coupled to the second thrust bearing.

Example 5: A linear actuator according to Example 4, further comprising a threaded connection formed between the coupling cover and the motor casing, wherein a preload on the coupling cover to form the threaded connection preloads the coupling stack.

Example 6: A linear actuator according to Example 5, wherein the coupling cover is axially aligned with the motor casing along the longitudinal axis, wherein the coupling cover includes an internally threaded end portion, and wherein the motor frame includes an externally threaded end portion that is received within and engaged with the internally threaded end portion to form the threaded connection.

Example 7: A linear actuator according to Example 5, wherein the coupling stack further comprises a first radial bearing adjacent to the first thrust bearing, the first radial bearing to support a radial load on the ball screw shaft.

Example 8: A linear actuator according to Example 7, further comprising a shim disposed between an outer ring member of the first radial bearing and the first thrust bearing, wherein the shim isolates the first thrust bearing from the radial load supported by the first radial bearing.

Example 9: A linear actuator according to Example 7, wherein the coupling cover comprises a first end portion proximate the first thrust bearing, and wherein the first radial bearing is mounted in an opening formed in the first end portion of the coupling cover.

Example 10: A linear actuator according to Example 9, wherein the first thrust bearing and the first radial bearing are parts of a combined thrust and axial bearing.

Example 11: A linear actuator according Example 9, further comprising a second radial bearing adjacent to the second thrust bearing, the second radial bearing to support a radial load on the motor shaft.

Example 12: A linear actuator according to Example 11, wherein the second radial bearing is disposed in an annular groove defined between the motor shaft and motor casing and retained in the annular groove by a retainer ring supported by the motor casing.

Example 13: A linear actuator according Example 12, wherein the retainer ring is disposed between an outer ring of the second radial bearing and the second thrust bearing to isolate the second thrust bearing from the radial load supported by the second radial bearing.

Example 14: A linear actuator according to Example 12, wherein the opening formed in the first end portion of the coupling cover includes a first annular shoulder, and wherein the first radial bearing includes a flange portion abutting the first annular shoulder.

Example 15: A linear actuator according to Example 14, wherein the retainer ring projects radially from the motor casing to define a second annular shoulder in opposing relation to the first annular shoulder, and wherein the coupling stack extends between the first and second annular shoulders.

Example 16: A linear actuator according to any of Examples 1-15, wherein an end portion of the ball screw shaft received in the first coupling bore includes an externally threaded surface, and wherein the first coupling bore includes an internally threaded surface that engages the external threaded surface to form a threaded connection between the end portion of the ball screw shaft and the first coupling bore.

Example 17: A linear actuator according to Example 16, wherein the ball screw shaft comprises a first surface that engages the first end face and a second surface that engages a portion of the first coupling bore, wherein the first and second surfaces are orthogonal to each other.

Example 18: A linear actuator according to any of Examples 1-17, wherein the first coupling bore and the second coupling bore are connected inside the shaft coupling, and wherein the ends of the ball screw shaft and the motor shaft disposed within the respective first coupling bore and second coupling bore are spaced apart.

Example 19: A linear actuator according to Example 3, wherein the shaft coupling includes a tap hole connected to the second coupling bore, and wherein the motor shaft is fixedly coupled to the second coupling by a threaded pin inserted into the tap hole.

Example 20: A linear actuator according to Example 19, wherein the motor shaft includes an opening to receive and engage an end portion of the threaded pin.

Example 21: A linear actuator according to Example 20, wherein the coupling cover includes an access opening for external access to the tap hole.

Example 22: A linear actuator according to any of Examples 1-21, wherein the ball screw comprises a nut disposed around and movably engaged with the ball screw shaft, and wherein rotation of the ball screw shaft relative to the nut causes linear displacement of the nut along the ball screw shaft or linear displacement of the nut along the ball screw shaft causes rotation of the ball screw shaft.

Example 23: A linear actuator according to any of Examples 1-22, wherein the motor is a direct current motor.

Example 24: A linear actuator according to Example 23: wherein the motor is a brushless direct-current motor.

Example 22: A method includes measuring electrical current passing through a motor of a linear actuator, wherein a motor shaft of the motor is rigidly coupled to a ball screw shaft of a ball screw of the actuator; determining a back-drive torque on the ball screw shaft; determining an opposing torque to output by the motor to resist the back-drive torque; determining an amount of electrical current to apply to the motor based at least in part on the opposing torque; and applying the amount of electrical current to the motor.

Example 23: A method according to Example 22, wherein determining the amount of electrical current to apply to the motor based at least in part on the opposing torque comprises determining a first portion of the amount of electrical current based on the opposing torque and determining a second portion of the amount of electrical current based on a force setpoint for the actuator.

1. A linear actuator comprising:
a coupling stack comprising:
a shaft coupling axially aligned with a longitudinal axis, the shaft coupling comprising a first end face and a second end face spaced apart along the longitudinal axis, a first coupling bore connected to the first end face, and a second coupling bore connected to the second end face;
a first thrust bearing adjacent to the first end face of the shaft coupling and having a first bearing bore aligned with the first coupling bore, the first thrust bearing configured to support an axial load applied to the shaft coupling in a first direction along the longitudinal axis; and
a second thrust bearing adjacent to the second end face of the shaft coupling and having a second bearing bore aligned with the second coupling bore, the second thrust bearing configured to support an axial load applied to the shaft coupling in a second direction that is opposite to the first direction along the longitudinal axis;
a ball screw having a ball screw shaft rigidly coupled to the shaft coupling, wherein the ball screw shaft has an end disposed in the first coupling bore and extends through the first bearing bore; and
a motor having a motor shaft rigidly coupled to the shaft coupling, wherein the motor shaft has an end disposed in the second coupling bore and extends through the second bearing bore, wherein the motor is operable to apply a torque to the motor shaft that is transmitted to the ball screw shaft through the shaft coupling.

2. The linear actuator of claim 1, wherein the first coupling bore and the second coupling bore are axially aligned with the longitudinal axis.

3. The linear actuator of claim 2, further comprising a coupling cover disposed around the coupling stack and mechanically coupled to the first thrust bearing.

4. The linear actuator of claim 3, further comprising a motor casing disposed around the motor and mechanically coupled to the second thrust bearing.

5. The linear actuator of claim 4, further comprising a threaded connection formed between the coupling cover and the motor casing, wherein a preload on the coupling cover to form the threaded connection preloads the coupling stack.

6. The linear actuator of claim 5, wherein the coupling stack further comprises a first radial bearing adjacent to the first thrust bearing, the first radial bearing to support a radial load on the ball screw shaft.

7. The linear actuator of claim 6, wherein an outer ring of the first radial bearing mechanically engages the coupling cover, and further comprising a shim disposed between the outer ring of the first radial bearing and the first thrust bearing to form a mechanical link between the first thrust bearing and the coupling cover.

8. The linear actuator of claim 6, wherein the coupling cover comprises a first end portion proximate the first thrust bearing, and wherein the first radial bearing is mounted in an opening formed in the first end portion.

9. The linear actuator of claim 8, further comprising a second radial bearing adjacent to the second thrust bearing, the second radial bearing to support a radial load on the motor shaft.

10. The linear actuator of claim 9, wherein the second radial bearing is disposed in an annular groove defined between the motor shaft and motor casing and retained in the annular groove by a retainer ring supported by the motor casing.

11. The linear actuator of claim 10, wherein the retainer ring is disposed between an outer member of the second radial bearing and the second thrust bearing to isolate the second thrust bearing from the radial load supported by the second radial bearing.

12. The linear actuator of claim 1, wherein an end portion of the ball screw shaft received in the first coupling bore includes an externally threaded surface, and wherein the first coupling bore includes an internally threaded surface that engages the external threaded surface to form a threaded connection between the end portion of the ball screw shaft and the first coupling bore.

13. The linear actuator of claim 12, wherein the ball screw shaft comprises a first surface that engages the first end face and a second surface that engages a portion of the first bore, and wherein the first and second surfaces are orthogonal to each other.

14. The linear actuator of claim 1, wherein the shaft coupling includes a tap hole connected to the second coupling bore, and wherein the motor shaft is fixedly coupled to the second coupling bore by a threaded pin inserted into the tap hole.

15. The linear actuator of claim 14, wherein the motor shaft includes an opening to receive and engage an end portion of the threaded pin, and wherein the coupling cover includes an access opening for external access to the tap hole.

16. The linear actuator of claim 1, wherein the ball screw comprises a nut disposed around and movably engaged with the ball screw shaft, and wherein rotation of the ball screw shaft relative to the nut causes linear displacement of the nut along the ball screw shaft or linear displacement of the nut along the ball screw shaft causes rotation of the ball screw shaft.

17. The linear actuator of claim 1, wherein the motor is a direct current motor.

18. The linear actuator of claim 1, wherein the motor is a brushless direct-current motor.

19. A method comprising:
measuring electrical current passing through a motor of a linear actuator, wherein a motor shaft of the motor is rigidly coupled to a ball screw shaft of a ball screw of the actuator;
determining a back-drive torque on the ball screw shaft;
determining an opposing torque to output by the motor to resist the back-drive torque;
determining an amount of electrical current to apply to the motor based at least in part on the opposing torque; and
applying the amount of electrical current to the motor.

20. The method of claim 19, wherein determining the amount of electrical current to apply to the motor based at least in part on the opposing torque comprises determining a first portion of the amount of electrical current based on the opposing torque and determining a second portion of the amount of electrical current based on a force setpoint for the actuator.
